(19) United States
(12) Patent Application Publication
(10) Pub. No.: US 2015/0371678 A1
(43) Pub. Date: Dec. 24, 2015

(54) PROCESSING AND TRANSMISSION OF AUDIO, VIDEO AND METADATA

(71) Applicant: THOMSON LICENSING, Issy de Moulineaux (FR)

(72) Inventor: Yannick DESROCHERS, Sainte-Catherine (CA)

(21) Appl. No.: 14/731,475

(22) Filed: Jun. 5, 2015

Related U.S. Application Data
(60) Provisional application No. 62/014,333, filed on Jun. 19, 2014.

(51) Int. Cl. G11B 27/031; H04N 5/222

(52) U.S. Cl. CPC G11B 27/031; H04N 5/2228

(57) ABSTRACT

A method and apparatus are described including receiving video data and video metadata, receiving audio data and audio metadata, receiving any other captured data and any other captured metadata, receiving any manually entered data, determining if any of the received data may be combined, combining any received data that is able to be combined and transmitting any combined data and any data that was not able to be combined to a studio apparatus. Also described are a method and apparatus including receiving data from a movie set, parsing received video metadata, parsing received audio metadata, validating said received data, said parsed video metadata and said parsed audio metadata and transmitting processed data back to said movie set.

### RELATED APPLICATIONS

This application claims the benefit of U.S. Provisional Patent Application No. 62/014,333 filed 19 Jun. 2014.

### FIELD OF THE INVENTION

The present invention relates to a variety of data from a professional movie set “shoot” and its transmission to a studio for processing along with data at the studio and then its transmission back to the director on the movie set. The purpose is for the director to be able to determine in near real-time whether the scene needs to be “re-shot” before the actors and crew are released from the set.

### BACKGROUND OF THE INVENTION

Audio, video and metadata from a movie shoot site (movie set) are collected individually. This data must be combined and processed to determine if the video shoot must be redone (re-shot). Often, the facilities are not on site to do this processing resulting in a considerable and costly delay between the shoot and the examination of the results. Delays may not only be costly but impossible to recover from. For example, if the scene is being “shot” (recorded, captured) outside and the lighting or weather conditions changes then the director may find it impossible to recreate the particular mood or ambience he/she wished to create.

Video, audio and data collected at a movie shoot site (movie set) is typically individually saved on storage devices, such as hard drives, and shipped via courier to a central location for processing. The processed data is then shipped back to the movie shoot site (movie set) and/or another location via a storage device. This turn around typically takes up to 24 hours. Several other methods are growing up to replace the transmission via physical storage device, but do not include the collecting and the combining solution proposed by the present invention.

### SUMMARY OF THE INVENTION

The invention is a method and apparatus for collecting, combining and transmission of video data, audio data and metadata collected at a movie shoot location (movie set). Data is collected from each device used, time stamped, combined into a collected data using an appropriate format. The collected data may or may not be compressed. The data may then be transmitted via a network to a central location for processing. The process may include an automated validation, a human validation, a report generation and an automated file conversion. The processed data may be transmitted back to the video shoot location for use by the video shoot crew and also transmitted to other location for use by other production departments.

The method and apparatus of the present invention will automate the combination of a variety of data in a variety of formats and combine the various data in order to speed up the transmission to a central location, the processing (combination) of the variety of data and its subsequent transmission back to the movie set in order for the director to determine if the scene has to be re-shot (redone).

A method and apparatus are described including receiving video data and video metadata, receiving audio data and audio metadata, receiving any other captured data and any other captured metadata, receiving any manually entered data, determining if any of the received data may be combined, combining any received data that is able to be combined and transmitting any combined data and any data that was not able to be combined to a studio apparatus. Also described are a method and apparatus including receiving data from a movie set, parsing received video metadata, parsing received audio metadata, validating said received data, said parsed video metadata and said parsed audio metadata and transmitting processed data back to said movie set.

### BRIEF DESCRIPTION OF THE DRAWINGS

The present invention is best understood from the following detailed description when read in conjunction with the accompanying drawings. The drawings include the following figures briefly described below:

FIG. 1 is a block diagram of the various data and its location and combination in accordance with the principles of the present invention.

FIG. 2 is a flowchart of an exemplary method for the operation of a device on the movie set, which collects data from various active source devices on the movie set.

FIG. 3 is a flowchart of an exemplary method for the operation of a device on the movie set which receives processed data from the studio.

FIGS. 4A and 4B together are a flowchart of an exemplary method for operation of a studio (centralized location) in processing the data received from a movie set.

FIG. 5 is a block diagram of an exemplary “on set” device such as would be used to perform the method described in FIG. 2 in accordance with the principles of the present invention.

FIG. 6 is a block diagram of an exemplary studio device such as would be used to perform the method described in FIGS. 4A and 4B in accordance with the principles of the present invention.

### DETAILED DESCRIPTION OF THE PREFERRED EMBODIMENTS

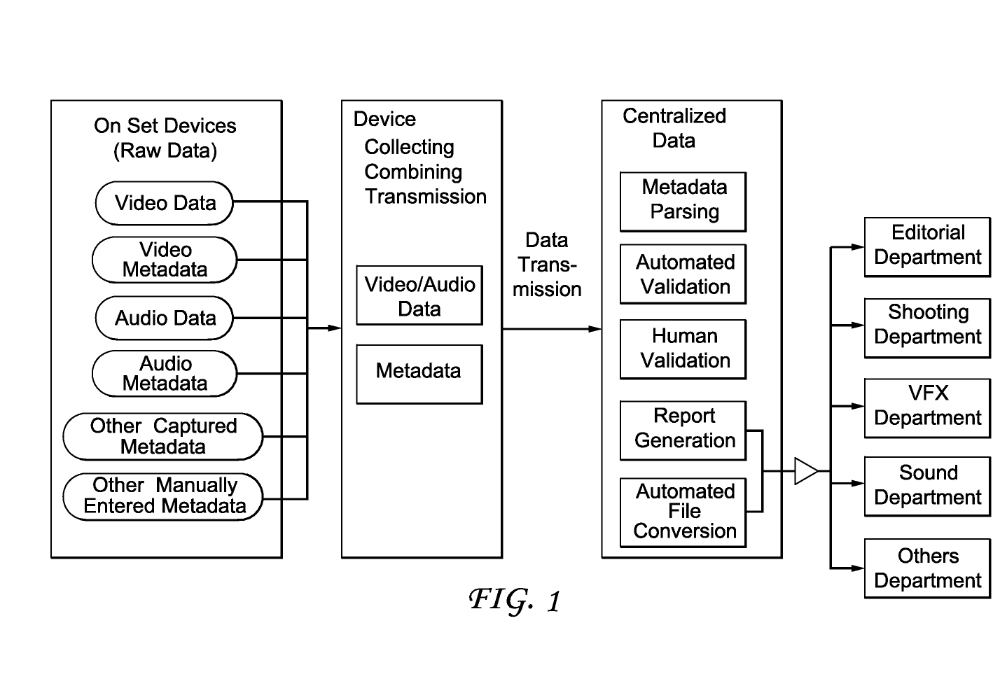

Referring to FIG. 1, the raw data from the movie set may include any or all of video data, video metadata, audio data, audio metadata, other captured data and any other manually entered data. Video data is obviously video data captured by a video camera. A video camera (video capture device) may be analog or digital. Analog video data may be captured at a variety of speeds (frames per second). Digital video data may be captured in a variety of formats. Metadata in general is data about data so video metadata is data or information about the video data that was captured on the movie set. Video metadata contains information about the video data and may include capture speed, data format, recording format, location where the video data was captured, date and time of the video data capture, lighting information, the make and model of the camera or cameras used to capture the scene, etc. Multiple cameras may have been used, for example, in the situation where the movie is to be viewed in a 3D or stereo format.

Audio data is data that is captured by an audio recording device. Audio data may be captured by analog audio equipment or digital audio recording equipment. Analog audio data may be captured at a variety of speeds (frames per second). Digital audio data may be captured in a variety of formats. Metadata in general is data about data so audio metadata is data or information about the audio data that was captured on the movie set. Audio metadata contains information about the audio data and may include capture speed, data format, recording format, location where the audio data was captured, date and time of the audio data capture, the make and model of the audio recording device or audio recording devices used to capture the scene audio data, etc. Multiple audio recording devices may have been used, for example, in the situation where the movie is in a stereo format.

Other captured data and metadata may include any other information captured by any other equipment on the set, such as light meters, directors instructions to the crew or the actors, etc. Data may be manually entered into a computer file. Such manually entered data may include data such as notes from various crew members or the director. It may include directional information regarding the equipment.

The various data and metadata are collected, combined (where possible) and transmitted to a central location for processing.

Central location processing may include combining and/or compiling the various data. Processing may also include reformatting the various data into one or more formats. The various data and metadata may also be combined or merged with data from a centralized data base. The metadata pay be parsed and automatically validated by equipment and/or validated manually by a person. Reports are generated about the various data and metadata and the various files of data may be converted to other file formats for storage or other uses.

The processed data is then transmitted back to the movie set for approval of the director before the set is dismantled or the scene shoot wrapped. The processed data is also transmitted to the editorial department, the video special effects department, the audio or sound department (for the addition of music or audio special effects) and any other department needing copies of the data. As used herein the term departments may also include other entities that are not within the studio. Such entities may include other corporate entities that provide services to the studio.

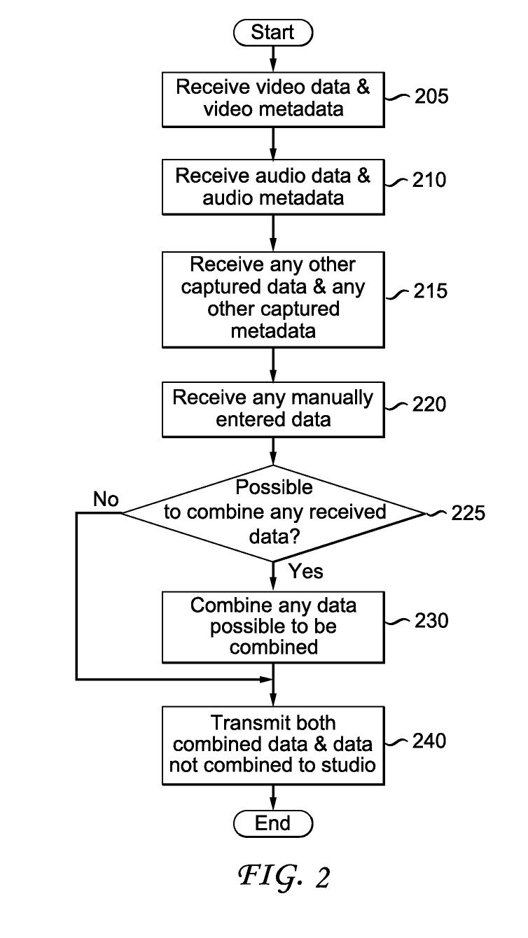

FIG. 2 is a flowchart of an exemplary method for the operation of a device on the movie set, which collects data from various active source devices on the movie set. The device on the movie set (the “on set” device) may be a computer, a laptop, a notebook computer or any other processing device including a special purpose processor. The source devices may be connected to the “on set” device wirelessly or by wired lines or may receive data via a removable storage (memory) device such as a thumb drive, CDs or any other form of removable storage. At 205 the “on set” device receives video data and video metadata. As noted above video data may be from an analog camera or a digital camera (video recording device) and may be from a single camera or a plurality of cameras. At 210 the “on set” device receives audio data and audio metadata. As noted above audio data may be from an analog recording device or a digital recording device and may be from a single audio recording device or a plurality of audio recording devices. At 215 the “on set” device receives any other captured data and any other captured metadata. At 220 the “on set” device receives any manually entered data. At 225, the “on set” device determines if it is possible to combine any of the received data. If it is possible to combine any of the received data, this is performed at 230. Combination of data may be, for example, data from a plurality of audio or video recording devices. Combination may be sequential or integrated. That is, for example, video form a plurality of cameras may be combined into a single file by starting with a data from a first camera and moving to data from a second camera etc. until data from all video recording devices has been “combined” in sequence (one after another) to form one large file. Combination may alternatively be integrated such as when two data from two video recording devices is combined on a frame by frame basis. This might occur when the director wants two specific cameras to be used for a stereo effect so that a frame from a first video recording device is stored in a file followed by a frame from a second video recording device. The same may occur with respect to combining audio data. Metadata from combined filed may be before the combined files or following the combined files or if the files are combined sequentially between the files. At 240 any combined data along with any other received data, that was not possible to combine, are transmitted to the studio for processing.

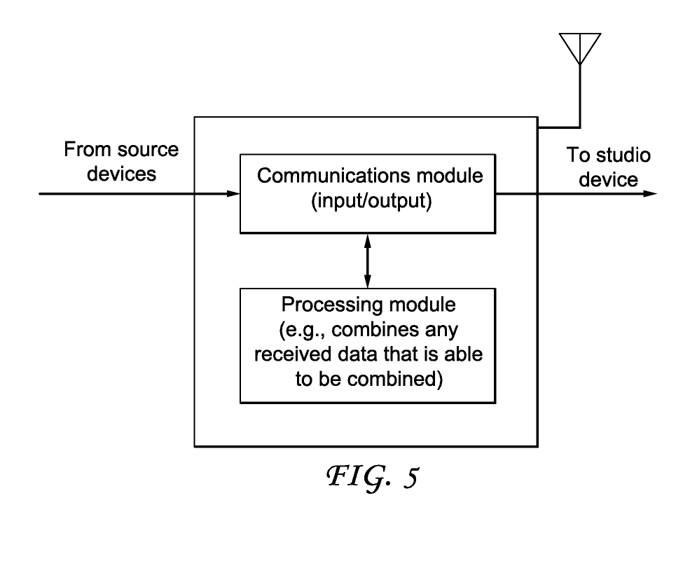

FIG. 5 is a block diagram of an exemplary “on set” device such as would be used to perform the method described in FIG. 2 in accordance with the principles of the present invention. The “on set” device receives the data (audio, audio metadata, video, video metadata, etc.) from other “on set” devices and combines the received data if possible and transmits the data (combined and not combined) to an apparatus at a studio. The “on set” apparatus includes means for receiving video data and video metadata, means for receiving audio data and audio metadata, means for receiving any other captured data and any other captured metadata, means for receiving any manually entered data, means for determining if any of the received data may be combined, means for combining any received data that is able to be combined and means for transmitting any combined data and any data that was not able to be combined to a studio apparatus. The reception means, as noted above, may be wirelessly, by wired line or by removable storage media. The reception means, as noted above, may be wirelessly or by wired line.

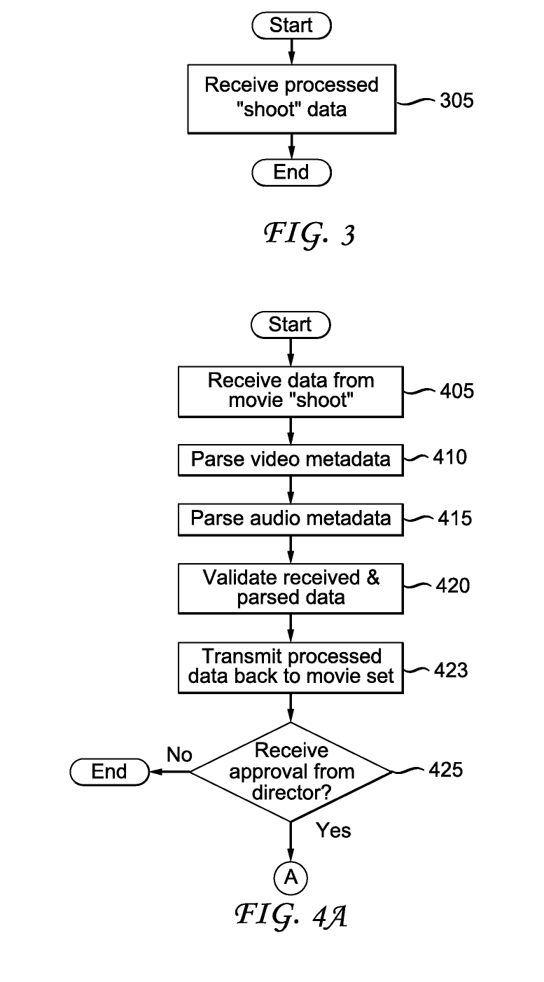

FIG. 3 is a flowchart of an exemplary method for the operation of a device on the movie set which receives processed data from the studio. The “on set” device waits until it receives processed data from the studio at 305 and makes the processed data available for the director to review.

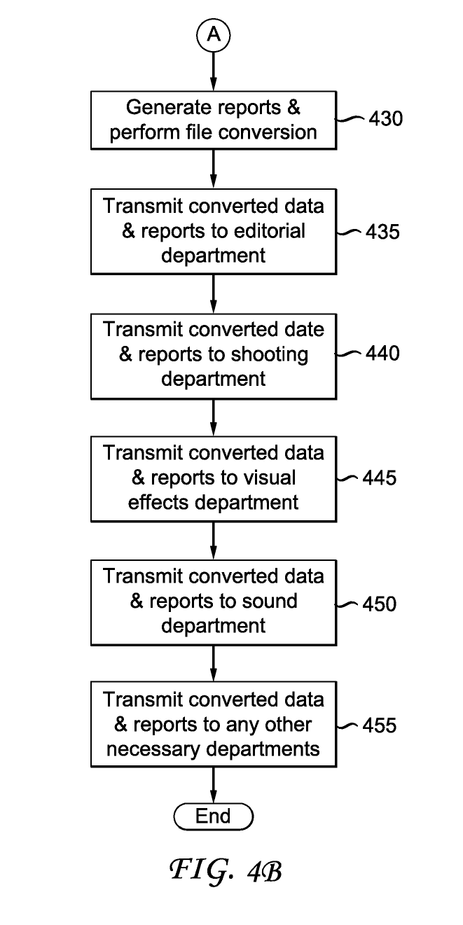

FIGS. 4A and 4B together are a flowchart of an exemplary method for operation of a studio (centralized location) in processing the data received from a movie set. At the studio there are processing devices such as computers, laptops, notebook computers and special purpose processing devices. One or more of these devices receives transmissions from the movie “shoot” in order to provide near real-time processing of the data and to then return (transmit) the processed data back to the movie set in order for the director to review and approve the captured scene. At 405 the studio device (apparatus) receives data from the movie “shoot” (shot (captured) on the “movie set”). At 410 the studio device parses the video metadata. At 415 the studio device parses the audio metadata. At 420 the studio device validates the received data and the parsed data. The validation may be automatic or manual or a combination of automatic and manual. At 423 the studio device transmits the processed data back to the “on set” device for the director to review.

At 425 the studio device determines if it has received approval of the processed data from the director. Approval by the director may be via the “on set” device transmitted to the studio device or may be by a phone call or an email or a text message. If the director has disapproved the processed data then the process ends. If the director has approved the processed data then at 430 the studio device generates reports and performs any file conversions. At 435 the studio device transmits any converted (file converted) data and reports to the editorial department. At 440 the studio device transmits any converted (file converted) data and reports to the shooting department. At 445 the studio device transmits any converted (file converted) data and reports to the visual effects department. At 450 435 the studio device transmits any converted (file converted) data and reports to the sound department. At 455 the studio device transmits any converted (file converted) data and reports to any other necessary departments. Any other necessary departments may include other non-studio entities such as other entities that are providing service for the movie such as corporate entities including, for example, Technicolor.

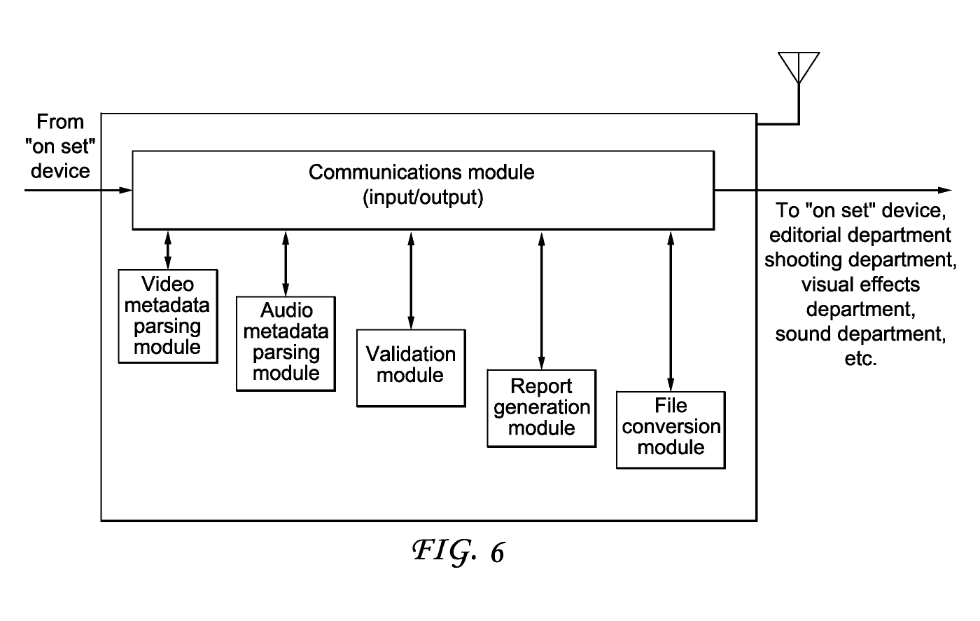

FIG. 6 is a block diagram of an exemplary studio device such as would be used to perform the method described in FIGS. 4A and 4B in accordance with the principles of the present invention. The studio device includes means for receiving data from a movie set (communications module), means for parsing received video metadata(video metadata parsing module), means for parsing received audio metadata (audio metadata parsing module), means for validating the received, the parsed video metadata and the parsed audio metadata data (validation module) and means for transmitting processed data back to the movie set (communications module). The studio device also includes means for determining if approval has been received and if the approval has been received, then further comprising means for generating reports from the received data (report generation module) and performing file conversions on the received data (file conversion module), means for transmitting the file converted data and the reports to an editorial department (communications module), means for transmitting the file converted data and the reports to a shooting department (communications module), means for transmitting the file converted data and the reports to a visual effects department (communications module) and means for transmitting the file converted data and the reports to a sound department (communications module). The studio device may also be a processor or a plurality of processors operating as a single unit. The processor(s) may be controlled by program instructions stored in any memory form and operate as described above.

It is to be understood that the present invention may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method, said method comprising;
receiving video data and video metadata from a first on set device;
receiving audio data and audio metadata from a second on set device;
receiving any other captured data and any other captured metadata from a third on set device;
receiving any manually entered data from a fourth on set device;
determining if any of the received data may be combined by a fifth on set device;
combining any received data that is able to be combined by said fifth on set device; and
transmitting by said fifth on set device any combined data and any data that was not able to be combined to a studio apparatus.

2. The method according to claim 1, wherein received data that is able to be combined is combined sequentially.

3. The method according to claim 1, wherein received data that is able to be combined is combined by integration.

4. The method according to claim 1, wherein metadata for said combined data is stored ahead of said combined data.

5. The method according to claim 1, wherein metadata for said combined data is stored after of said combined data.

6. The method according to claim 2, wherein metadata for said combined data is stored between units of combined data.

7. An apparatus, comprising;
means for receiving video data and video metadata from a first on set device;
means for receiving audio data and audio metadata from a second on set device;
means for receiving any other captured data and any other captured metadata from a third on set device;
means for receiving any manually entered data from a fourth on set device;
means for determining if any of the received data may be combined by a fifth on set device;
means for combining by said fifth on set device any received data that is able to be combined; and
means for transmitting by said fifth on set device any combined data and any data that was not able to be combined to a studio apparatus.

8. A method, said method comprising:
receiving data from a plurality of on set devices movie set by a studio device;
parsing by said studio device received video metadata;
parsing by said studio device received audio metadata;
validating by said studio device said received data, said parsed video metadata and said parsed audio metadata; and
transmitting by said studio device processed data back to said movie set.

9. The method according to claim 8, wherein said processed data includes said validated received data, said validated parsed video metadata and said validated parsed audio metadata.

10. The method according to claim 8, wherein said received data includes video data, video metadata, audio data, audio metadata, any other captured data, any other captured metadata and any manually entered data.

11. The method according to claim 8, further comprising determining if approval has been received and if said approval has been received, then further comprising:
generating reports from said received data and performing file conversions on said received data;
transmitting said file converted data and said reports to an editorial department;
transmitting said file converted data and said reports to a shooting department;
transmitting said file converted data and said reports to a visual effects department; and
transmitting said file converted data and said reports to a sound department.

12. An apparatus, comprising:
means for receiving data from a plurality of on set devices from a movie set by a studio device;
means for parsing received video metadata by said studio device;
means for parsing received audio metadata by said studio device;
means for validating said received data by said studio device, said parsed video metadata and said parsed audio metadata; and
means for transmitting by said studio device processed data back to said movie set.

13. The apparatus according to claim 12, further comprising means for determining if approval has been received and if said approval has been received, then further comprising:
means for generating reports from said received data and performing file conversions on said received data;
means for transmitting said file converted data and said reports to an editorial department;
means for transmitting said file converted data and said reports to a shooting department;
means for transmitting said file converted data and said reports to a visual effects department; and
means for transmitting said file converted data and said reports to a sound department.
